(19) United States
(12) Patent Application Publication
(10) Pub. No.: US 2019/0101407 A1
(43) Pub. Date: Apr. 4, 2019

(54) NAVIGATION METHOD AND DEVICE BASED ON AUGMENTED REALITY, AND ELECTRONIC DEVICE

(71) Applicant: BEIJING KINGSOFT INTERNET SECURITY SOFTWARE CO., LTD., Beijing (CN)

(72) Inventor: Sha Cao, Beijing (CN)

(73) Assignee: BEIJING KINGSOFT INTERNET SECURITY SOFTWARE CO., LTD., Beijing (CN)

(21) Appl. No.: 16/104,408

(22) Filed: Aug. 17, 2018

(30) Foreign Application Priority Data
Sep. 29, 2017 (CN) 201710909876.1

(51) Int. Cl. G01C 21/36; G06T 19/00; G01C 21/20

(52) U.S. Cl. CPC G01C 21/3638; G01C 21/20; G01C 21/3667; G06T 19/006

(57) ABSTRACT

The present disclosure provides a navigation method and a device based on augmented reality (AR), an electronic device, and a medium. The method includes: displaying a three-dimensional real image under an AR scene; determining route information to be navigated in the displayed three-dimensional real image; determining at least one intermediate location according to the route information; configuring a preset navigation widget at each intermediate location, to perform navigation based on the navigation widget.

### CROSS REFERENCE TO RELATED APPLICATION

This application is based on and claims priority of Chinese Patent Application No. 201710909876.1, filed on Sep. 29, 2017, the entire contents of which are incorporated herein by reference.

### FIELD

The present disclosure relates to an electronic device technology field, and more particularly to a navigation method and a device based on augmented reality, and an electronic device.

### BACKGROUND

Applications of map navigation type are platforms providing travel related services including intelligent route planning, intelligent navigation (such as for driving, walking, riding, etc.), real-time traffic status, and the like for a user. In the related art, an application of map navigation type generally shows a route to be used for navigation in a way of two-dimension after the route to be used for navigation is determined.

In this way, the navigation effect is not illustrative enough.

### SUMMARY

Embodiments of the present disclosure provide a navigation method based on AR, including: displaying a three-dimensional real image under an AR scene; determining route information to be navigated in the displayed three-dimensional real image; determining at least one intermediate location according to the route information; configuring a preset navigation widget at each intermediate location, to perform navigation based on the navigation widget.

Embodiments of the present disclosure provide a navigation device based on AR, including: a non-transitory computer-readable medium comprising computer-executable instructions stored thereon, and an instruction execution system which is configured by the instructions to implement at least one of: a displaying module, configured to display a three-dimensional real image under an AR scene; a first determining module, configured to determine route information to be navigated in the displayed three-dimensional real image; a second determining module, configured to determine at least one intermediate location according to the route information; a navigating module, configured to configure a preset navigation widget at each intermediate location, to perform navigation based on the navigation widget.

Embodiments of the present disclosure provide an electronic device, including: a processor, a memory, a power circuit, a multimedia component, an audio component, an input/output (I/O) interface, a sensor component, and a communication component. The power circuit is configured to provide power to various circuits or components of the device. The memory is configured to store executable program code. The processor is configured to execute a program corresponding to the executable program code by reading the executable program code stored in the memory, so as to implement: displaying a three-dimensional real image under an AR scene; determining route information to be navigated in the displayed three-dimensional real image; determining at least one intermediate location according to the route information; configuring a preset navigation widget at each intermediate location, to perform navigation based on the navigation widget.

Embodiments of the present disclosure provide a non-transitory computer-readable storage medium, when instructions stored on the storage medium is executed by a processor of an electronic device, the electronic device is caused to implement a navigation method based on AR, including: displaying a three-dimensional real image under an AR scene; determining route information to be navigated in the displayed three-dimensional real image; determining at least one intermediate location according to the route information; configuring a preset navigation widget at each intermediate location, to perform navigation based on the navigation widget.

Embodiments of the present disclosure provide a computer program product, configured to, when instructions in the computer program product is performed by a processor, implement a navigation method based on AR, including: displaying a three-dimensional real image under an AR scene; determining route information to be navigated in the displayed three-dimensional real image; determining at least one intermediate location according to the route information; configuring a preset navigation widget at each intermediate location, to perform navigation based on the navigation widget.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow chart of a navigation method based on augmented reality according to an embodiment of the present disclosure;

FIG. 2 is a flow chart of a navigation method based on augmented reality according to another embodiment of the present disclosure;

FIG. 3 is a schematic diagram illustrating effect of navigation based on augmented reality according to embodiments of the present disclosure;

FIG. 4 is a flow chart of a navigation method based on augmented reality according to another embodiment of the present disclosure;

FIG. 5 is a flow chart of a navigation method based on augmented reality according to another embodiment of the present disclosure;

FIG. 6 is a block diagram illustrating a navigation device based on augmented reality according to an embodiment of the present disclosure;

FIG. 7 is a block diagram illustrating a navigation device based on augmented reality according to another embodiment of the present disclosure;

FIG. 8 is a schematic diagram illustrating an electronic device according to an embodiment of the present disclosure.

### DETAILED DESCRIPTION

Reference will be made in detail to embodiments of the present disclosure. Examples of the embodiments are shown in the drawings. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure. Instead, the embodiments of the present disclosure comprise all the variants, modifications and their equivalents within the spirit and scope of the present disclosure as defined by the claims.

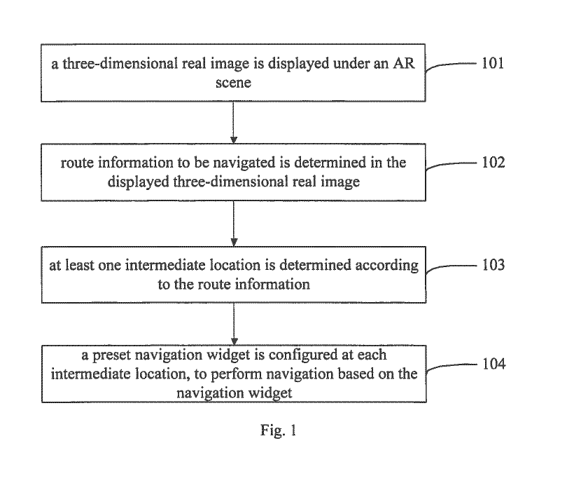

FIG. 1 is a flow chart of a navigation method based on augmented reality (AR) according to an embodiment of the present disclosure.

For example, in this embodiment, the navigation method based on AR is configured in a navigation device based on AR.

The navigation device based on AR in this embodiment may be configured in a server or a mobile device, which is not limited in embodiments of the present disclosure.

The navigation method based on AR according to embodiments of the present disclosure may be used in a navigation function module of an application of map navigation type, which is not limited in embodiments of the present disclosure.

The application may be a software application running on an electronic device. For example, the electronic device may be a personal computer (PC), a cloud device, or a mobile device. The mobile device may be a smart phone, a tablet computer, or the like.

It should be noted that, an executing subject of the embodiment of the present disclosure may be, for example, a central processing unit (CPU) in a server or a mobile device on hardware, and may be, for example, a background management service of a map navigation application in a server or a mobile device on software, which is not limited in embodiments of the present disclosure.

Referring to FIG. 1, the method includes followings.

At block 101, a three-dimensional real image is displayed under an AR scene.

AR is a technology for calculating a photographing position and a photographing angle of a camera and adding corresponding images, videos, and three-dimensional model on a location determined by the calculated photographing position and the photographing angle. AR aims to apply a virtual world into a real world, and to perform interaction.

In detail, an AR application may be started, the real image of a scene to be currently navigated is scanned by a photographing device (such as a camera) under the AR scene, and the three-dimensional real image of the scene to be currently navigated is displayed under the AR scene.

At block 102, route information to be navigated is determined in the displayed three-dimensional real image.

The route information includes a relative distance between a current geographic location and a target geographic location and a relative direction between the current geographic location and the target geographic location.

For example, the current geographic location may be a location where a user having a navigation requirement is located, and the target geographic location may be required by the user having a navigation requirement. In this embodiment, the current geographic location of the user may be located by using GPS. The target geographic location may be manually input by the user, or be obtained by analyzing location data sent from other users, which is not limited in embodiments of the present disclosure.

In embodiments of the present disclosure, part of or all of functions of the AR application may be embedded in an application of map navigation type, such that the application of map navigation type can display the three-dimensional real image of the scene to be currently navigated under the AR scene when the user uses the application of map navigation type for navigation, providing more illustrative navigation impression to a user.

At block 103, at least one intermediate location is determined according to the route information.

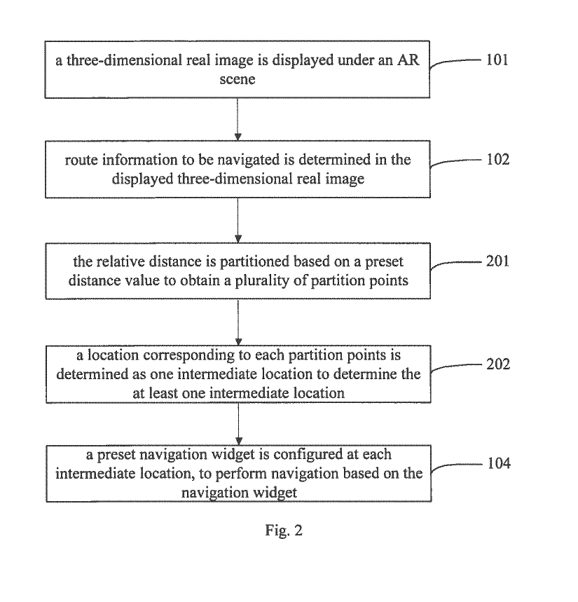

Alternatively, in some embodiments, referring to FIG. 2, determining at least one intermediate location according to the route information may includes followings.

At block 201, the relative distance is partitioned based on a preset distance value to obtain a plurality of partition points.

The preset distance value is set in advance by a factory program of the application of map navigation type or set by a user of the application of map navigation type according to self demands. It is not limited in embodiments of the present disclosure.

The relative distance may be a distance calibrated in the map according to the distance between the current geographic location and the target geographic location in a real scene. For example, the distance in a real scene is 1000 meters, correspondingly, the relative distance may be 10 centimeters.

In detail, the preset distance value may be a distance calibrated in the map according to a preset distance value in a real scene. For example, the preset distance value in a real scene is 100 meters, correspondingly, the calibrated distance of the preset distance value in a real scene in the map may be 1 centimeters.

In this embodiment, for example, partitioning the relative distance based on the preset distance value to obtain a plurality of partition points may be as follows. A relative distance of 10 centimeters displayed in the map is partitioned based on an interval of 1 centimeter to obtain a plurality of partition points. A distance between each two partition points is 1 centimeter. Alternatively, in this embodiment, the relative distance may be partitioned based on different preset distances, which is not limited.

At block 202, a location corresponding to each partition points is determined as one intermediate location to determine the at least one intermediate location.

In this embodiment, by partitioning the relative distance based on the preset distance value to obtain the plurality of partition points, and determining the location corresponding to each partition points as one intermediate location to determine the at least one intermediate location, more concise and more artistic navigation impression may be provided to the user in subsequent arranging a preset widget. In addition, the relative distance is partitioned based on the preset distance, therefore, it is easy to implement with a high implementing efficiency.

At block 104, a preset navigation widget is configured at each intermediate location, to perform navigation based on the navigation widget.

For example, the preset navigation widget may be a tile, a three-dimensional object, and the like. The preset navigation widget may be uploaded by a user, or may be called from a local file base by the user, which is not limited.

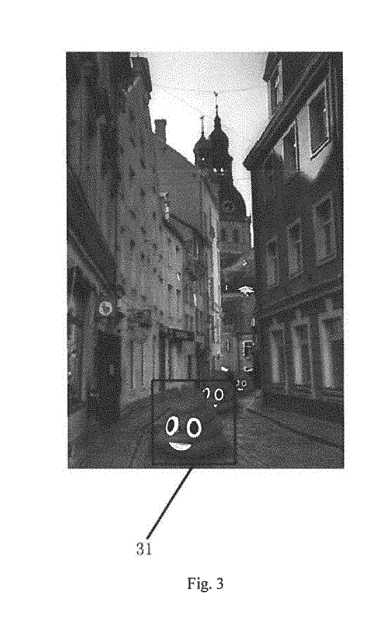

Referring to FIG. 3, FIG. 3 is a schematic diagram illustrating effect of navigation based on AR according to embodiments of the present disclosure. A background in FIG. 3 is the three-dimensional real image displayed under the AR scene, including a plurality of navigation widgets 31. It can be seen from FIG. 3, the preset widget is configured at each intermediate location, to perform navigation, providing the user with more illustrative navigation impression.

Alternatively, the route information further includes a relative direction between the current geographic location and the target geographic location. In embodiments of the present disclosure, the preset navigation widget may be configured at each intermediate location according to the relative direction, to perform the navigation. For example, if the preset widget is an arrow-like icon, an arrow direction of the arrow-like icon may be adjusted according to the relative direction while configuring the arrow-like icon on each intermediate location.

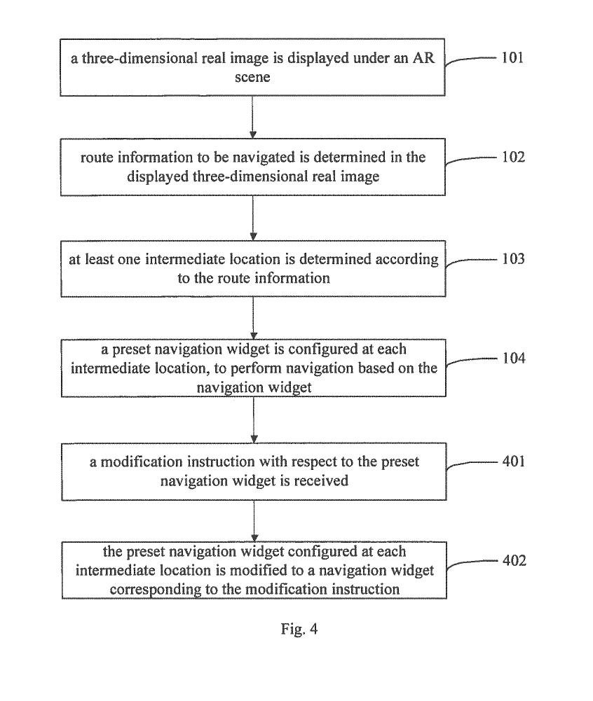

Alternatively, in some embodiments, referring to FIG. 4, after configuring a preset navigation widget at each intermediate location, to perform navigation based on the navigation widget, the method may further include follows.

At block 401, a modification instruction with respect to the preset navigation widget is received.

At block 402, the preset navigation widget configured at each intermediate location is modified to a navigation widget corresponding to the modification instruction.

In this embodiment, by supporting modification of the preset navigation widget, applicability and completeness of the method are improved.

Further, alternatively, in some embodiments, referring to FIG. 5, after the step at block 104, the method may include follows.

At block 501, during the navigation, the current geographic location in real time is updated to obtain a new geographic location.

At block 502, the three-dimensional real image and the route information to be navigated are updated according to the new geographic location.

It could be understood that, during the navigation, the user may move with the navigation information. Therefore, in this embodiment, a current geographic location of the user may be monitored in real time. When a displacement of the user generates, the current geographic location of the user is updated in real time to obtain a new geographic location, and the three-dimensional real image and the route information to be navigated are updated according to the new geographic location.

In this embodiment, by updating the three-dimensional real image and the route information to be navigated according to the new geographic location, accuracy and timeliness of the navigation may be effectively ensured.

In this embodiment, by displaying the three-dimensional real image under the AR scene, determining route information to be navigated in the displayed three-dimensional real image, determining at least one intermediate location according to the route information, and configuring the preset navigation widget at each intermediate location, to perform the navigation based on the navigation widget, the three-dimensional real image of a scene to be currently navigated may be displayed under the AR scene, and more illustrative navigation impression is provided to a user, improving navigation effect.

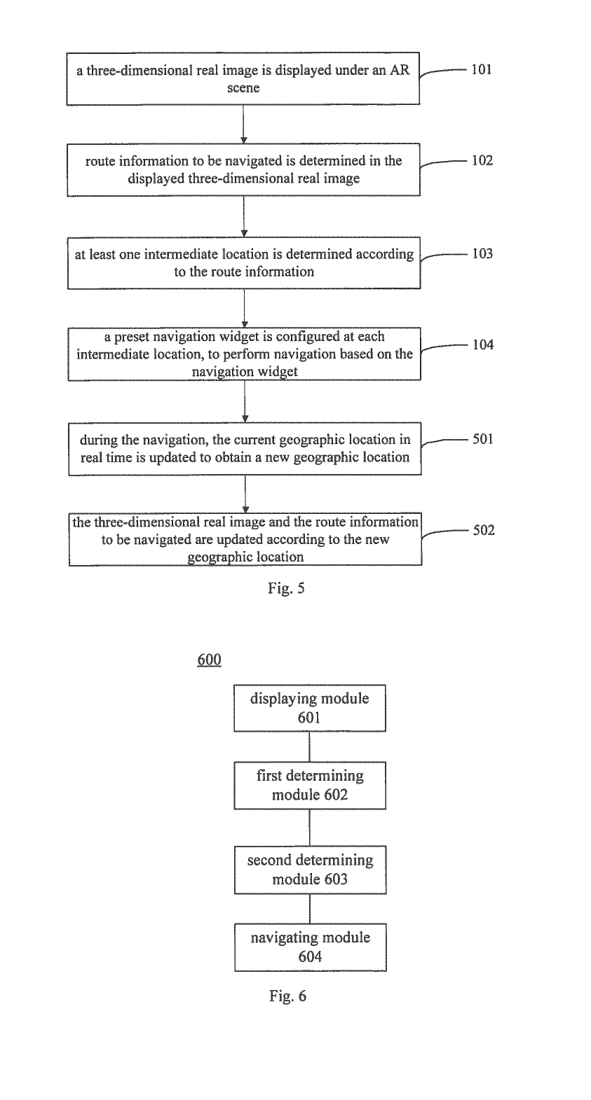

FIG. 6 is a block diagram illustrating a navigation device based on AR according to an embodiment of the present disclosure.

Referring to FIG. 6, the device 600 may include a displaying module 601, a first determining module 602, a second determining module 603 and a navigating module 604.

The displaying module 601 is configured to display a three-dimensional real image under an AR scene.

The first determining module 602 is configured to determine route information to be navigated in the displayed three-dimensional real image.

The second determining module 603 is configured to determine at least one intermediate location according to the route information.

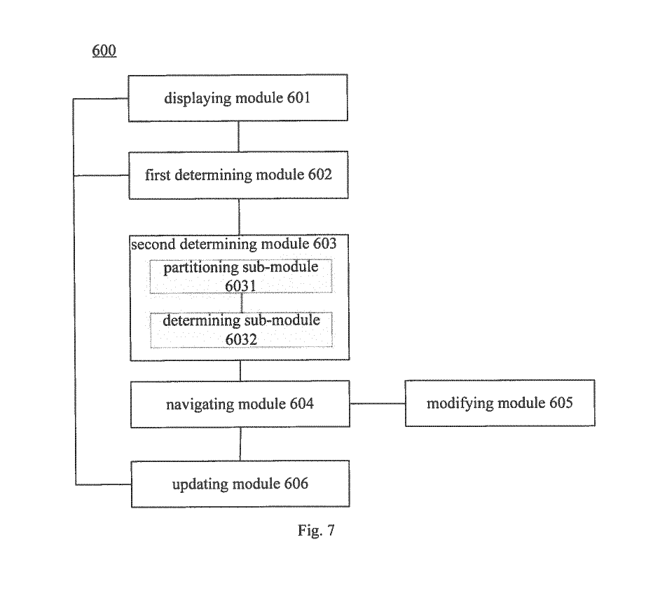

Alternatively, in some embodiments, referring to FIG. 7, the route information includes a relative distance between a current geographic location and a target geographic location, and the second determining module 603 includes a partitioning sub-module 6031 and a determining sub-module 6032.

The partitioning sub-module 6031 is configured to partition the relative distance based on a preset distance value to obtain a plurality of partition points.

The determining sub-module 6032 is configured to determine a location corresponding to each partition points as one intermediate location to determine the at least one intermediate location.

The navigating module 604 is configured to configure a preset navigation widget at each intermediate location, to perform navigation based on the navigation widget.

Alternatively, in some embodiments, referring to FIG. 7, the device may further include a modifying module 605 and an updating module 606.

The modifying module 605 is configured to receive a modification instruction with respect to the preset navigation widget, and to modify the preset navigation widget configured at each intermediate location to a navigation widget corresponding to the modification instruction.

The updating module 606 is configured to, during the navigation, update the current geographic location in real time to obtain a new geographic location, and update the three-dimensional real image and the route information to be navigated according to the new geographic location.

Alternatively, in some embodiments, the route information further includes a relative direction between the current geographic location and the target geographic location, and the navigating module 604 is configured to: configure the preset navigation widget at each intermediate location according to the relative direction, to perform navigation based on the navigation widget.

It should be noted that, descriptions of the navigation method based on AR in foregoing embodiments illustrated in FIG. 1 to FIG. 5 are suitable for the navigation device 600 based on AR. Implementation principles of them are similar, and it is not described in detail herein.

In this embodiment, by displaying the three-dimensional real image under the AR scene, determining route information to be navigated in the displayed three-dimensional real image, determining at least one intermediate location according to the route information, and configuring the preset navigation widget at each intermediate location, to perform the navigation based on the navigation widget, the three-dimensional real image of a scene to be currently navigated may be displayed under the AR scene, and more illustrative navigation impression is provided to a user, improving navigation effect.

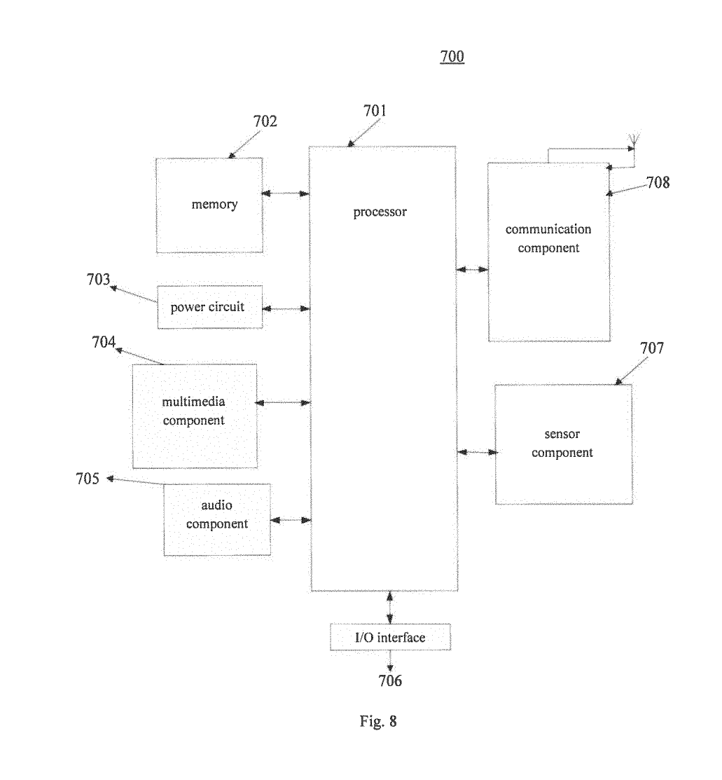

The present disclosure further provides an electronic device. Referring to FIG. 8, the electronic device 800 includes one or more of following components: a processor 701, a memory 702, a power circuit 703, a multimedia component 704, an audio component 705, an input/output (I/O) interface 706, a sensor component 707, and a communication component 708.

The power circuit 703 is configured to provide power to various circuits or components of the device. The memory 702 is configured to store executable program code. The processor 701 is configured to execute a program corresponding to the executable program code by reading the executable program code stored in the memory 702, so as to implement followings: displaying a three-dimensional real image under an AR scene; determining route information to be navigated in the displayed three-dimensional real image; determining at least one intermediate location according to the route information; configuring a preset navigation widget at each intermediate location, to perform navigation based on the navigation widget.

In an embodiment of the present disclosure, the route information includes a relative distance between a current geographic location and a target geographic location, determining at least one intermediate location according to the route information includes: partitioning the relative distance based on a preset distance value to obtain a plurality of partition points; determining a location corresponding to each partition points as one intermediate location to determine the at least one intermediate location.

In an embodiment of the present disclosure, after configuring a preset navigation widget at each intermediate location, to perform navigation based on the navigation widget, the processor 701 is further configured to implement: receiving a modification instruction with respect to the preset navigation widget; modifying the preset navigation widget configured at each intermediate location to a navigation widget corresponding to the modification instruction.

In an embodiment of the present disclosure, the route information further includes a relative direction between the current geographic location and the target geographic location, configuring a preset navigation widget at each intermediate location, to perform navigation based on the navigation widget includes: configuring the preset navigation widget at each intermediate location according to the relative direction, to perform navigation based on the navigation widget.

In an embodiment of the present disclosure, the processor 701 is further configured to implement: during the navigation, updating the current geographic location in real time to obtain a new geographic location; updating the three-dimensional real image and the route information to be navigated according to the new geographic location.

It should be noted that, descriptions of the navigation method based on AR in foregoing embodiments illustrated in FIG. 1 to FIG. 5 are suitable for the electronic device 700 based on AR. Implementation principles of them are similar, and it is not described in detail herein.

In this embodiment, by displaying the three-dimensional real image under the AR scene, determining route information to be navigated in the displayed three-dimensional real image, determining at least one intermediate location according to the route information, and configuring the preset navigation widget at each intermediate location, to perform the navigation based on the navigation widget, the three-dimensional real image of a scene to be currently navigated may be displayed under the AR scene, and more illustrative navigation impression is provided to a user, improving navigation effect.

To achieve the above objectives, the present disclosure further provides a non-transitory computer-readable storage medium, when instructions stored on the storage medium is executed by a processor of an electronic device, the electronic device is caused to implement a navigation method based on AR, including: displaying a three-dimensional real image under an AR scene; determining route information to be navigated in the displayed three-dimensional real image; determining at least one intermediate location according to the route information; configuring a preset navigation widget at each intermediate location, to perform navigation based on the navigation widget.

In an embodiment of the present disclosure, the route information includes a relative distance between a current geographic location and a target geographic location, determining at least one intermediate location according to the route information includes: partitioning the relative distance based on a preset distance value to obtain a plurality of partition points; determining a location corresponding to each partition points as one intermediate location to determine the at least one intermediate location.

In an embodiment of the present disclosure, after configuring a preset navigation widget at each intermediate location, to perform navigation based on the navigation widget, the method further includes: receiving a modification instruction with respect to the preset navigation widget; modifying the preset navigation widget configured at each intermediate location to a navigation widget corresponding to the modification instruction.

In an embodiment of the present disclosure, the route information further includes a relative direction between the current geographic location and the target geographic location, configuring a preset navigation widget at each intermediate location, to perform navigation based on the navigation widget includes: configuring the preset navigation widget at each intermediate location according to the relative direction, to perform navigation based on the navigation widget.

In an embodiment of the present disclosure, the method further includes: during the navigation, updating the current geographic location in real time to obtain a new geographic location; updating the three-dimensional real image and the route information to be navigated according to the new geographic location.

With the non-transitory computer-readable storage medium according to embodiments of the fourth aspect of the present disclosure, by displaying the three-dimensional real image under the AR scene, determining route information to be navigated in the displayed three-dimensional real image, determining at least one intermediate location according to the route information, and configuring the preset navigation widget at each intermediate location, to perform the navigation based on the navigation widget, the three-dimensional real image of a scene to be currently navigated may be displayed under the AR scene, and more illustrative navigation impression is provided to a user, improving navigation effect.

To achieve the above objectives, the present disclosure further provides a computer program product, configured to, when instructions in the computer program product is performed by a processor, implement a navigation method based on AR, including: displaying a three-dimensional real image under an AR scene; determining route information to be navigated in the displayed three-dimensional real image; determining at least one intermediate location according to the route information; configuring a preset navigation widget at each intermediate location, to perform navigation based on the navigation widget.

In an embodiment of the present disclosure, the route information includes a relative distance between a current geographic location and a target geographic location, determining at least one intermediate location according to the route information includes: partitioning the relative distance based on a preset distance value to obtain a plurality of partition points; determining a location corresponding to each partition points as one intermediate location to determine the at least one intermediate location.

In an embodiment of the present disclosure, after configuring a preset navigation widget at each intermediate location, to perform navigation based on the navigation widget, the method further includes: receiving a modification instruction with respect to the preset navigation widget; modifying the preset navigation widget configured at each intermediate location to a navigation widget corresponding to the modification instruction.

In an embodiment of the present disclosure, the route information further includes a relative direction between the current geographic location and the target geographic location, configuring a preset navigation widget at each intermediate location, to perform navigation based on the navigation widget includes: configuring the preset navigation widget at each intermediate location according to the relative direction, to perform navigation based on the navigation widget.

In an embodiment of the present disclosure, the method further includes: during the navigation, updating the current geographic location in real time to obtain a new geographic location; updating the three-dimensional real image and the route information to be navigated according to the new geographic location.

With the computer program product according to embodiments of the fifth aspect of the present disclosure, by displaying the three-dimensional real image under the AR scene, determining route information to be navigated in the displayed three-dimensional real image, determining at least one intermediate location according to the route information, and configuring the preset navigation widget at each intermediate location, to perform the navigation based on the navigation widget, the three-dimensional real image of a scene to be currently navigated may be displayed under the AR scene, and more illustrative navigation impression is provided to a user, improving navigation effect.

It should be noted that, in the description of the present disclosure, terms such as “first” and “second” are used herein for purposes of description and are not intended to indicate or imply relative importance or significance. In addition, in the description of the present disclosure, “a plurality of” means two or more than two, unless specified otherwise.

Any process or method described in a flow chart or described herein in other ways may be understood to include one or more modules, segments or portions of codes of executable instructions for achieving specific logical functions or steps in the process, and the scope of an embodiment of the present disclosure includes other implementations, in which functions may be not performed in an order that is not shown or discussed, including in a substantially simultaneous manner or in an opposite order according to the functions involved, which should be understood by those skilled in the art.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It can be understood that all or part of the steps in the method of the above embodiments can be implemented by instructing related hardware via programs, the program may be stored in a computer readable storage medium, and the program includes one step or combinations of the steps of the method when the program is executed.

In addition, individual functional units in the embodiments of the present disclosure may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The above-mentioned storage medium may be a read-only memory, a magnetic disc, an optical disc, etc.

Reference throughout this specification to “one embodiment”, “some embodiments”, “an example”, “a specific example”, or “some examples” means that a particular feature, structure, material, or characteristic described in connection with the embodiment or example is included in at least one embodiment or example of the present disclosure. Thus, the appearances of the phrases such as “one embodiment”, “some embodiments”, “an example”, “a specific example”, or “some examples” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A navigation method based on augmented reality (AR), comprising:
displaying a three-dimensional real image under an AR scene;
determining route information to be navigated in the displayed three-dimensional real image;
determining at least one intermediate location according to the route information;
configuring a preset navigation widget at each intermediate location to perform navigation based on the navigation widget.

2. The navigation method according to claim 1, wherein the route information comprises a relative distance between a current geographic location and a target geographic location, determining at least one intermediate location according to the route information comprises:
partitioning the relative distance based on a preset distance value to obtain a plurality of partition points;
determining a location corresponding to each partition point as one intermediate location to determine the at least one intermediate location.

3. The navigation method according to claim 1, after configuring a preset navigation widget at each intermediate location to perform navigation based on the navigation widget, further comprising:
receiving a modification instruction with respect to the preset navigation widget;
modifying the preset navigation widget configured at each intermediate location to a navigation widget corresponding to the modification instruction.

4. The navigation method according to claim 2, wherein the route information further comprises a relative direction between the current geographic location and the target geographic location, configuring a preset navigation widget at each intermediate location to perform navigation based on the navigation widget comprises:
configuring the preset navigation widget at each intermediate location according to the relative direction, to perform navigation based on the navigation widget.

5. The navigation method according to claim 1, further comprising:
during the navigation, updating the current geographic location in real time to obtain a new geographic location;
updating the three-dimensional real image and the route information to be navigated according to the new geographic location.

6. The navigation method according to claim 1, wherein the preset navigation widget comprises at least one of a tile and a three-dimensional object.

7. The navigation method according to claim 4, wherein the preset navigation widget is an arrow-like icon, a direction corresponding to the arrow-like icon is configured based on the relative direction.

8. A navigation device based on augmented reality (AR), comprising a non-transitory computer-readable medium comprising computer-executable instructions stored thereon, and an instruction execution system which is configured by the instructions to implement at least one of:
a displaying module, configured to display a three-dimensional real image under an AR scene;
a first determining module, configured to determine route information to be navigated in the displayed three-dimensional real image;
a second determining module, configured to determine at least one intermediate location according to the route information;
a navigating module, configured to configure a preset navigation widget at each intermediate location, to perform navigation based on the navigation widget.

9. The navigation device according to claim 8, wherein the route information comprises a relative distance between a current geographic location and a target geographic location, the second determining module comprises:
a partitioning sub-module, configured to partition the relative distance based on a preset distance value to obtain a plurality of partition points;
a determining sub-module, configured to determine a location corresponding to each partition points as one intermediate location to determine the at least one intermediate location.

10. The navigation device according to claim 8, wherein the instruction execution system is further configured by the instructions to implement:
a modifying module, configured to receive a modification instruction with respect to the preset navigation widget, and to modify the preset navigation widget configured at each intermediate location to a navigation widget corresponding to the modification instruction.

11. The navigation device according to claim 9, wherein the route information further comprises a relative direction between the current geographic location and the target geographic location, the navigating module is configured to:
configure the preset navigation widget at each intermediate location according to the relative direction, to perform navigation based on the navigation widget.

12. The navigation device according to claim 8, wherein the instruction execution system is further configured by the instructions to implement:
an updating module, configured to, during the navigation, update the current geographic location in real time to obtain a new geographic location, and update the three-dimensional real image and the route information to be navigated according to the new geographic location.

13. The navigation device according to claim 8, wherein the preset navigation widget comprises at least one of a tile and a three-dimensional object.

14. The navigation device according to claim 11, wherein the preset navigation widget is an arrow-like icon, a direction corresponding to the arrow-like icon is configured based on the relative direction.

15. An electronic device, comprising one or more of a processor, a memory, a power circuit, a multimedia component, an audio component, an input/output (I/O) interface, a sensor component, and a communication component; wherein, the power circuit is configured to provide power to various circuits or components of the device, the memory is configured to store executable program code; the processor is configured to execute a program corresponding to the executable program code by reading the executable program code stored in the memory, so as to implement a navigation method based on augmented reality (AR), the method comprises:
displaying a three-dimensional real image under an AR scene;
determining route information to be navigated in the displayed three-dimensional real image;
determining at least one intermediate location according to the route information;
configuring a preset navigation widget at each intermediate location to perform navigation based on the navigation widget.

16. The electronic device according to claim 15, wherein the route information comprises a relative distance between a current geographic location and a target geographic location, determining at least one intermediate location according to the route information comprises:
partitioning the relative distance based on a preset distance value to obtain a plurality of partition points;
determining a location corresponding to each partition point as one intermediate location to determine the at least one intermediate location.

17. The electronic device according to claim 15, after configuring a preset navigation widget at each intermediate location to perform navigation based on the navigation widget, the method further comprising:
receiving a modification instruction with respect to the preset navigation widget;
modifying the preset navigation widget configured at each intermediate location to a navigation widget corresponding to the modification instruction.

18. The electronic device according to claim 16, wherein the route information further comprises a relative direction between the current geographic location and the target geographic location, configuring a preset navigation widget at each intermediate location to perform navigation based on the navigation widget comprises:
configuring the preset navigation widget at each intermediate location according to the relative direction, to perform navigation based on the navigation widget.

19. The electronic device according to claim 15, the method further comprising:
during the navigation, updating the current geographic location in real time to obtain a new geographic location;
updating the three-dimensional real image and the route information to be navigated according to the new geographic location.

20. The electronic device according to claim 15, wherein the preset navigation widget comprises at least one of a tile and a three-dimensional object.
